(19) United States
(12) Patent Application Publication
(10) Pub. No.: US 2005/0242473 A1
(43) Pub. Date: Nov. 3, 2005

(54) Uniform thermal distribution imaging

(75) Inventors: Kenneth J. Newell, Dana Point, CA (US); Bradley D. Geving, Newhall, CA (US)

Correspondence Address: 3D Systems, Inc., 26081 Avenue Hall, Valencia, CA, 91355, US

(73) Assignee: 3D Systems, Inc.

(21) Appl. No.: 10/833,426

(22) Filed: Apr. 28, 2004

(51) Int. Cl. B29C 35/08; B29C 41/02

(52) U.S. Cl. 264/497; 425/174.4

(57) ABSTRACT

A method of obtaining uniform thermal distribution imaging in a thermally initiated and thermally based laser sintering process whereby a three-dimensional object is formed layer-by-layer in which the scanning sequences in successive layers is varied to more uniformly control the build up of heat within a three-dimensional object being formed. An improved method of image scanning multiple parts in a single build process is also employed.

### BACKGROUND OF THE INVENTION

1. Field of the Invention

This invention relates to the field of freeform fabrication, and more specifically is directed to the fabrication of three-dimensional objects by selective laser sintering utilizing an improved scanning technique. 2. Description of the Related Art

The field of freeform fabrication of parts has, in recent years, made significant improvements in providing high strength, high density parts for use in the design and pilot production of many useful articles. Freeform fabrication generally refers to the manufacture of articles directly from computer-aided-design (CAD) databases in an automated fashion, rather than by conventional manual machining of prototype articles according to engineering drawings. As a result, the time required to produce prototype parts from engineering designs has been reduced from several weeks to a matter of a few hours.

By way of background, an example of a freeform fabrication technology is the selective laser sintering process practiced in systems available from 3D Systems, Inc., in which articles are produced from a laser-fusible powder in layerwise fashion. According to this process, a thin layer of powder is dispensed and then fused, melted, or sintered, by laser energy that is directed to those portions of the powder corresponding to a cross-section of the article. Conventional selective laser sintering systems, such as the Vanguard system available from 3D Systems, Inc., position the laser beam by way of galvanometer-driven mirrors that deflect the laser beam. The deflection of the laser beam is controlled, in combination with modulation of the laser itself, to direct laser energy to those locations of the fusible powder layer corresponding to the cross-section of the article to be formed in that layer. The computer based control system is programmed with information indicative of the desired boundaries of a plurality of cross sections of the part to be produced. The laser may be scanned across the powder in raster fashion, with modulation of the laser affected in combination therewith, or the laser may be directed in vector fashion. In some applications, cross-sections of articles are formed in a powder layer by fusing powder along the outline of the cross-section in vector fashion either before or after a raster scan that “fills” the area within the vector-drawn outline. In any case, after the selective fusing of powder in a given layer, an additional layer of powder is then dispensed, and the process repeated, with fused portions of later layers fusing to fused portions of previous layers as appropriate for the article, until the article is complete.

Detailed description of the selective laser sintering technology may be found in U.S. Pat. Nos. 4,863,538; 5,132,143; and 4,944,817, all assigned to Board of Regents, The University of Texas System, and in U.S. Pat. No. 4,247,508 to Housholder, all incorporated herein by this reference.

The selective laser sintering technology has enabled the direct manufacture of three-dimensional articles of high resolution and dimensional accuracy from a variety of materials including polystyrene, some nylons, other plastics, and composite materials such as polymer coated metals and ceramics. Polystyrene parts may be used in the generation of tooling by way of the well-known “lost wax” process. In addition, selective laser sintering may be used for the direct fabrication of molds from a CAD database representation of the object to be molded in the fabricated molds; in this case, computer operations will “invert” the CAD database representation of the object to be formed, to directly form the negative molds from the powder.

Laser sintering is a thermally based process that is dependent upon good thermal control of the process in the powder bed to obtain good three-dimensional parts. The sources of thermal energy are the radiant heaters for the part bed, the cylinder heaters to preheat the powder in the powder feed cylinders, the part bed heater, and the laser. The laser is typically a CO₂ laser that scans the fresh powder layer to selectively fuse powder particles in the desired areas. Unequal build-up of heat in one portion of the part bed during the process results in parts being fabricated having unequal properties or for larger individual parts, having different properties within the same part.

Existing laser sintering systems increasingly have the need to produce parts with greater strength and improved physical properties to meet the demands of the increasing number of applications for laser sintering products. Although the design of the present commercial systems has proven to be very effective in delivering both powder and thermal energy in a precise and efficient way, there is a need to improve the physical properties of the parts produced by the exposure of the powder layers at the target surface by the scanning laser. This need is successfully addressed by the scanning techniques of the present invention.

### BRIEF SUMMARY OF THE INVENTION

It is an aspect of the present invention that the powder bed for solidification is cross scanned by vectors that cross the target surface at 90 degree rotations on successive scans.

It is another aspect of the present invention that the cross-scanning pattern scans at 90 degree or orthogonally offset patterns from the prior scanning and goes through a four-pattern sequence before being repeated, regardless of whether all scanning is in one layer or successive layers of powder for solidification.

It is a feature of the present invention that the first or zero degree scan pattern starts from one corner of the target surface and the subsequent 90 degree rotations of the scans progress sequentially from there.

It is another feature of the present invention that the first and third scans and the second and forth scans may be selectively interleaved.

It is an advantage of the present invention that more uniform physical properties are obtained from laser sintered fabricated parts using the enhanced scanning techniques of the present invention.

It is another advantage of the present invention that less distortion resulting from heat build-up occurs when freeform fabrication parts are made utilizing the enhanced scanning techniques of the present invention.

It is a further advantage of the present invention that there is greater repeatability of freeform fabrication part properties from part-to-part when using the enhanced scanning techniques of the present invention.

It is yet another advantage of the present invention that parts with improved surface finish, quality, and easier break out from the part cake are obtained when using the enhanced scanning techniques of the present invention.

These and other aspects, features, and advantages are obtained from improved scanning techniques in a freeform fabrication powder-based technology such as laser sintering where powder particles are fused together from a scanning pattern that employs successive orthogonally offset and alternating opposed sweeping directions of the scanning energy beam.

### BRIEF DESCRIPTION OF THE DRAWINGS

These and other aspects, features and advantages of the invention will become apparent upon consideration of the following detailed disclosure, especially when taken in conjunction with the accompanying drawings wherein:

FIG. 1 is a diagrammatic illustration of a prior art selective laser sintering machine with portions cut away;

FIG. 2 is a diagrammatic front elevational view of a conventional prior art selective laser sintering machine showing some of the mechanisms involved;

FIG. 3 is a diagrammatic illustration of the laser scanning pattern employed for the first quantity of powder that has been spread on the powder bed to be exposed on the powder bed;

FIG. 4 is a diagrammatic illustration of the laser scanning pattern employed for the second quantity of powder that has been spread to form a fresh powder layer to be exposed on the powder bed;

FIG. 5 is a diagrammatic illustration of the laser scanning pattern employed for the third quantity of powder that has been spread to form a fresh powder layer to be exposed on the powder bed;

FIG. 6 is a diagrammatic illustration of the laser scanning pattern employed for the fourth quantity of powder that has been spread to form a fresh powder layer to be exposed on the powder bed; and

FIG. 7a and 7b is a diagrammatic illustration of the laser scanning sequence order employed for the scanning of multiple parts being built on a powder bed.

### DETAILED DESCRIPTION OF THE INVENTION

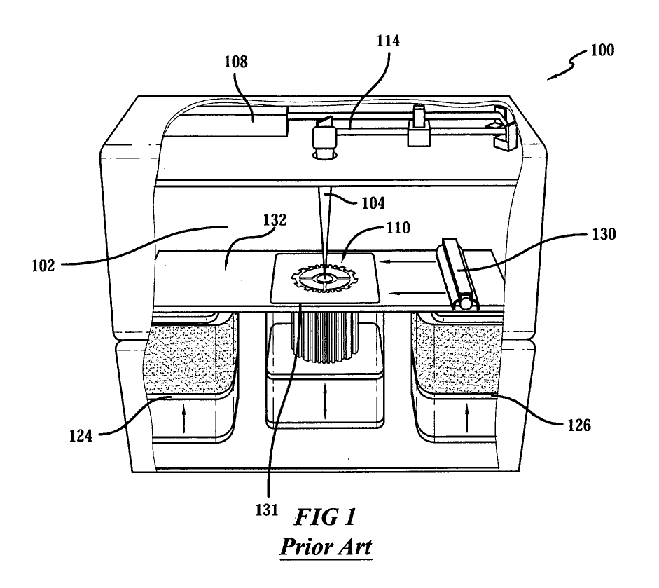

FIG. 1 illustrates, by way of background, a rendering of a conventional selective laser sintering system currently sold by 3D Systems, Inc. of Valencia, Calif. FIG. 1 is a rendering shown without doors for clarity. A carbon dioxide laser and its associated optics is shown mounted in a unit above a process chamber that includes a powder bed, two feed powder cartridges, and a leveling roller. The process chamber maintains the appropriate temperature and atmospheric composition for the fabrication of the article. The atmosphere is typically an inert atmosphere, such as nitrogen. It is also possible to use a vacuum in the process chamber.

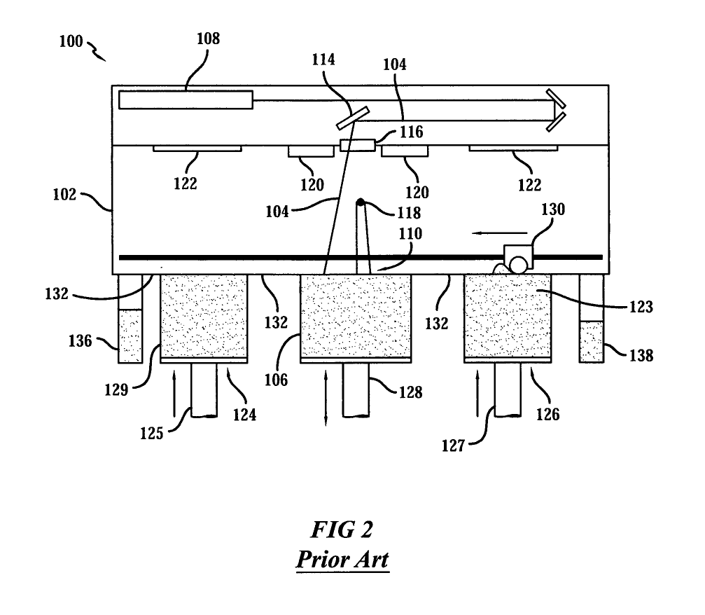

Operation of this conventional selective laser sintering system 100 is shown in FIG. 2 in a front view of the process with the doors removed for clarity. A laser beam 104 is generated by laser 108, and aimed at target surface or area 110 by way of scanning system 114 that generally includes galvanometer-driven mirrors which deflect the laser beam. The laser and galvonometer systems are isolated from the hot process chamber 102 by a laser window 116. The laser window 116 is situated within radiant heater elements 120 that heat the target area 110 of the part bed below. These heater elements 120 may be ring shaped (rectangular or circular) panels or radiant heater rods that surround the laser window 116. The deflection and focal length of the laser beam is controlled, in combination with the modulation of laser 108 itself, to direct laser energy to those locations of the fusible powder layer corresponding to the cross-section of the article to be formed in that layer. Scanning system 114 may scan the laser beam across the powder in a raster-scan fashion, or in vector fashion. It is understood that scanning entails the laser beam intersecting the powder surface in the target area 110.

Two feed systems (124,126) feed powder into the system by means of push up piston systems. A part bed 132 receives powder from the two feed pistons 125,127 as described immediately hereafter. Feed system 126 first pushes up a measured amount of powder from the powder in feed cylinder 123 and a counter-rotating roller 130 picks up and spreads the powder over the part bed 132 in a uniform manner. The counter-rotating roller 130 passes completely over the target area 110 and part bed 132. Any residual powder is deposited into an overflow receptacle 136. Positioned nearer the top of the process chamber 102 are radiant heater elements 122 that pre-heat the feed powder and a ring or rectangular shaped radiant heater element 120 for heating the part bed surface. Element 120 has a central opening which allows a laser beam 104 to pass through the optical element or laser window 116. After a traversal of the counter-rotating roller 130 across the part bed 132 the laser selectively fuses the layer just dispensed. The roller then returns from the area of the overflow receptacle 136, after which the feed system 124 pushes up a prescribed amount of powder from the powder in feed cylinder 129. The roller 130 then dispenses powder over the target 110 in the opposite direction and proceeds to the other overflow receptacle 138 to deposit any residual powder. Before the roller 130 begins each traverse of the system the center part bed piston 128 drops by the desired layer thickness to make room for additional powder.

The powder delivery system in system 100 includes feed pistons 125 and 127. Feed pistons 125 and 127 are controlled by motors (not shown) to move upwardly and lift, when indexed, a volume of powder into chamber 102. Part piston 128 is controlled by a motor (not shown) to move downwardly below the floor of process chamber 102 by a small amount, for example 0.125 mm, to define the thickness of each layer of powder to be processed. Roller 130 is a counter-rotating roller that translates powder from feed systems 124 and 126 onto target surface 110. When traveling in either direction the roller carries any residual powder not deposited on the target area into overflow receptacles (136,138) on either end of the chamber 102. Target surface 110, for purposes of the description herein, refers to the top surface of heat-fusible powder (including portions previously sintered, if present) disposed above part piston 128; the sintered and unsintered powder disposed on part piston 128 will be referred to herein as part cake 106. System 100 of FIG. 2 also requires radiant heaters 122 over the feed pistons to pre-heat the powder to minimize any thermal shock as fresh powder is spread over the recently sintered and hot target area 110. This type of dual piston feed system, providing fresh powder from below the target area, with heating elements for both feed beds and the part bed is implemented commercially in the Vanguard™ selective laser sintering system sold by 3D Systems, Inc. of Valencia, Calif.

Another known powder delivery system uses overhead hoppers to feed powder from above and either side of target area 110 in front of a delivery apparatus such as a wiper or scraper.

There are advantages and disadvantages to each of these systems. Both require a number of mechanisms, either push-up pistons or overhead hopper systems with metering feeders to effectively deliver metered amounts of powder to each side of the target area and in front of the spreading mechanism which typically is either a roller or a wiper blade.

The laser scanning techniques used in system 100 can have a marked effect on the heat distribution within the part bed 132 and the part cake 106. If the laser starts its scan at the same location in each layer of powder, there can be an unequal build-up of heat at that location in the part cake as the powder part bed 132 is repeatedly renewed with a fresh layer of powder. This can be true whether the particular powder material is a multi-material, such as a polymer coated metal, for example steel, or a single component powder such as nylon or polycarbonate. It has been a more frequently noted problem with multi-material powders, such as polymer coated steel.

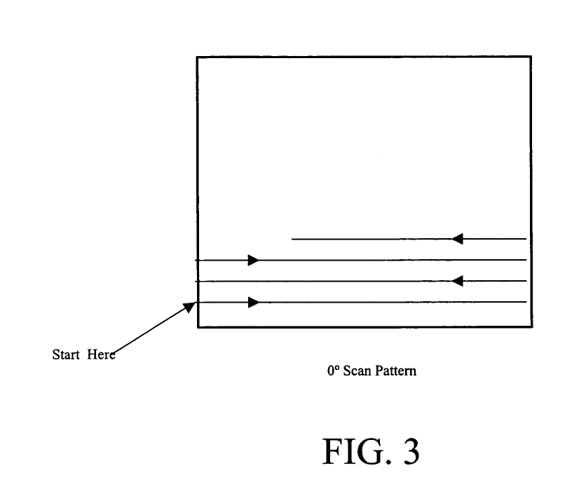

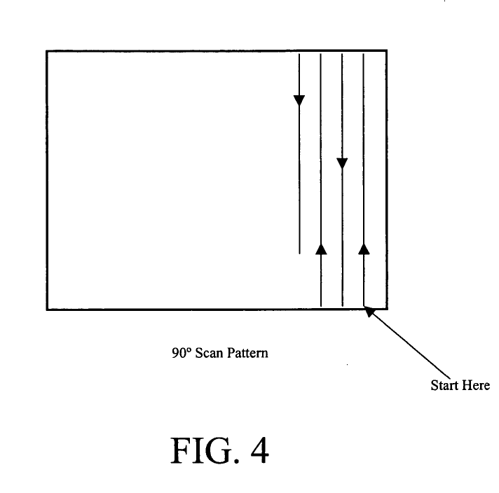

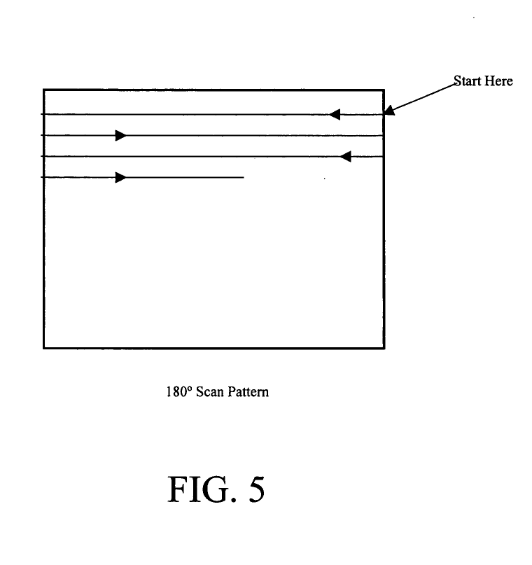

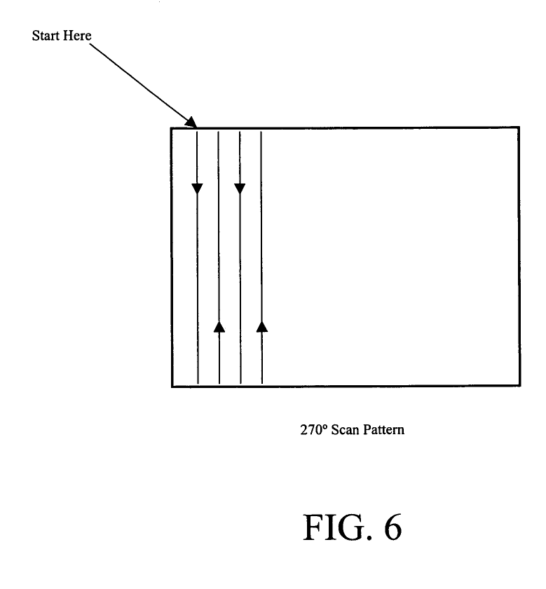

To address this potential non-uniform thermal distribution during laser imaging the laser scanning system 114 employs specific scanning patterns and paths to minimize the build-up of heat in any one particular location in the part bed 132 and the part cake 106. FIGS. 3-6 show the scanning pattern followed by the laser beam 104 in successive layers of fresh powder that are spread on the part bed 132 by the counter-rotating roller 130, or other appropriate spreading mechanism. Alternatively FIGS. 3-6 show the scanning pattern on successive scans, such as where multiple scans are used to expose each fresh layer of powder. The initial scanning or exposure of the powder layer is shown in FIG. 3 wherein the laser beam 104 starts its scanning at the lower left corner of the target area 110 and moves horizontally across the target area 110 in the process chamber 102 in opposing sequential parallel zig-zagged paths at a 020 angle. The next scan or exposure of the powder part bed 132 is shown in FIG. 4 wherein the laser beam 104 starts its scanning at the lower right corner of the target area 110 and moves vertically across the target area 110 in the process chamber 102 (appearing as upward and downward movements in FIG. 4) in opposing sequential parallel zig-zagged paths at a 90° angle or orthogonally offset from the scanning pattern employed in the exposure of the first layer of powder. The starting location for the laser beam 104 is also moved from the starting location of the scanning pattern in the previous layer of powder in the part bed 132. The next or third scan or exposure of the third layer of powder in the target area 110 is shown in FIG. 5 wherein the laser beam 104 starts its scanning at the upper right corner of the target area 110 and moves horizontally across the part bed 132 in the process chamber 102 in opposing sequential parallel zig-zagged paths at a 180° angle or orthogonally offset from the scanning pattern employed in the exposure of the second layer of powder. The starting location for the laser beam 104 is also moved from the starting location of the scanning pattern in the previous layer of powder in the target area 110. The last scan or exposure in the 4-step patterned laser scanning technique of the powder in target area 110 is shown in FIG. 6 wherein the laser beam 104 starts its scanning at the lower right corner of the target area 110 and moves vertically across the part bed 132 in the process chamber 102 (appearing as downward and upward movements in FIG. 6) in opposing sequential parallel zig-zagged paths at a 270° angle or orthogonally offset from the scanning pattern employed in the exposure of the third layer of powder. Again, the starting location for the laser beam 104 is moved from the starting location of the scanning pattern in the previous layer of powder in the target area 110.

This orthogonally offset scanning pattern helps reduce the build-up of heat in the part cake 106 as it increases in height layer by layer of powder that is scanned by not starting the scanning in the same location in the target area 110 or following the same scanning path each time, thereby allowing more time to pass and more of the laser heat energy to be spread throughout the part cake 106 facilitating uniform thermal distribution in the part cake 106 and the target area 110 during imaging. The four steps in the laser scanning pattern are continually repeated until the three-dimensional object being fabricated is completed. It is also desirable for selective parts to interleave the scanning paths during the exposure of the second and fourth quantities of powder with the scanning paths followed during the exposure of the first and third quantities of powder.

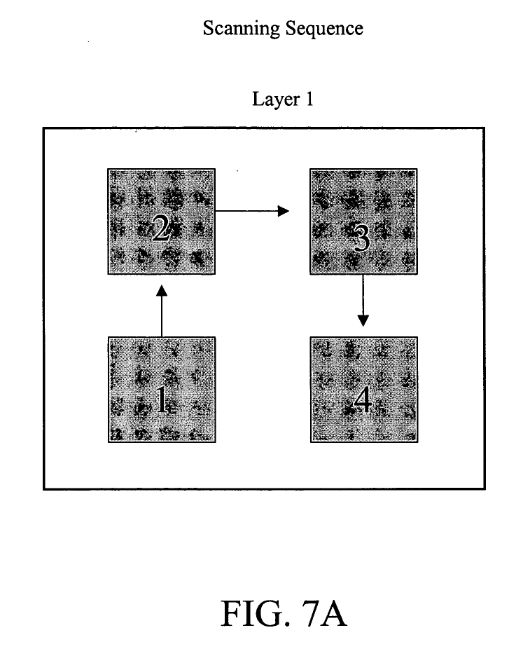

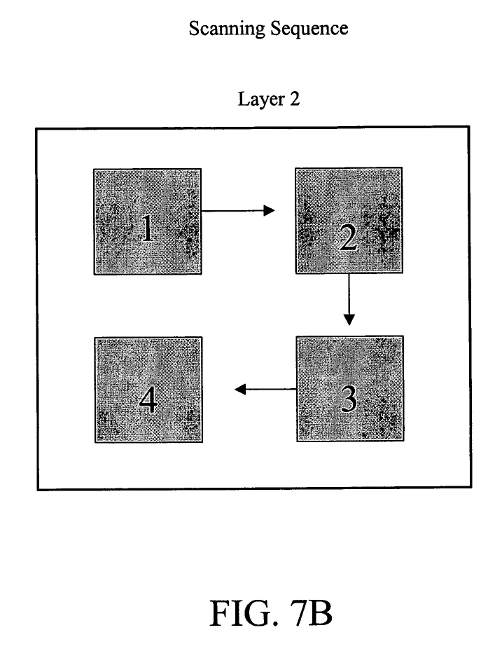

FIGS. 7A and 7B show the technique employed when multiple parts are being fabricated in a single build process in the laser sintering system 100. FIGS. 7A and 7B reflect 4 distinct parts being built in the process chamber 102 and their relative location in the generally geometrically shaped target area 110. As seen in the Figures, the target area 110 in part bed 132 is preferably rectangular or square in shape. Each of the four parts are numbered in their order of scanning so that the part numbered 1 is always the first part to be scanned and the others are scanned in ascending order. While only four parts are shown, it is to be understood that any multiple number of parts can illustrate the pattern whether greater of lesser in number. As shown between FIG. 7A and FIG. 7B the first part scanned is varied in each layer of powder scanned, moving from the upper left hand comer to the lower left hand comer. Subsequent layers of powder will have the start point for the laser scanning commence in the lower right hand comer and move to the upper right hand comer. This varied start point for the laser scanning operation by part helps reduce the build-up of heat in one part by not starting the scanning in the same part each time thereby allowing more time to pass and more of the laser heat energy to be spread through out the target area 110 and the part cake 106, further facilitating uniform thermal distribution during imaging when multiple parts are being fabricated. Alternatively, as was stated with respect to the orthogonally offset scanning pattern, the varied start point for the laser scanning operation can be utilized for each scan where there are multiple laser scans employed with each powder layer. In this alternative approach each scan would be accomplished in the ascending order shown in the Figures, regardless of the layer of powder being scanned and only with reference to the number of parts being built.

While the invention has been described above with references to specific embodiments, it is apparent that many changes, modifications and variations in the materials, arrangement of parts and steps can be made without departing from the inventive concept disclosed herein. For example and as previously mentioned, the improved scanning techniques can be employed for each scanning exposure of the laser beam and not just be limited by the number of layers of fresh powder deposited regardless of whether a single part or multiple parts are being fabricated in a build cycle. Accordingly, the spirit and broad scope of the appended claims is intended to embrace all such changes, modifications and variations that may occur to one of skill in the art upon a reading of the disclosure. All patent applications, patents and other publications cited herein are incorporated by reference in their entirety.

1. A method of obtaining uniform thermal distribution in a powder bed during laser sintering accomplished by scanning a powder layer having a geometrically shaped surface with an energy beam multiple times to form a three-dimensional object comprising the steps of:
a. delivering a quantity of powder to a location in a process chamber;
b. spreading the quantity of powder across at least a portion of the process chamber to form a powder layer in a powder bed, the powder layer having a generally defined geometric shape;
c. exposing the powder layer with an energy beam, the beam starting at a first location and moving in a first direction;
d. delivering a second quantity of powder to a location in the process chamber;
e. spreading the second quantity of powder across at least a portion of the process chamber to form a fresh powder layer;
f. exposing the fresh powder layer to the energy beam, the energy beam starting at a second location and moving in a second direction orthogonally offset from the first direction;
g. delivering a third quantity of powder to a location in the process chamber;
h. spreading the third quantity of powder across at least a portion of the process chamber to form a fresh powder layer;
i. exposing the fresh powder layer to the energy beam, the energy beam moving in a third direction orthogonally offset from the second direction and starting at a location different than the first location and the second location;
j. delivering a fourth quantity of powder to a location in the process chamber;
k. spreading a fourth quantity of powder across at least a portion of the process chamber to form a fresh powder layer;
l. exposing the fresh powder layer to the energy beam, the energy beam moving in a fourth direction orthogonally offset from the third direction and starting at a location different from the first location, the second location, and the third location; and
m. repeating steps a-l a predetermined number of times to complete building a three-dimensional object.

2. The method according to claim 1 further comprising the powder layer having a generally geometric shape with a plurality of comers, starting the movement of the energy beam from a first comer for the first quantity of powder and from a different comer for each of the second, third, and fourth quantities of powder.

3. The method according to claim 2 further comprising building multiple parts in the powder bed, each part being assigned adjacent to a comer so that the scanning movement of the energy beam begins over a different part for each layer.

4. The method according to claim 1 further comprising using a laser beam as the energy beam for the scanning of the powder.

5. The method according to claim 1 further comprising using a powder selected from a single material or a multi-material to form the three-dimensional object.

6. The method according to claim 5 further comprising using a multi-material comprising a polymer coated metal.

7. The method according to claim 5 further comprising using a polymer.

8. The method according to claim 1 further comprising the exposing steps for the first and third quantities of powder and the second and fourth quantities of powder are interleaved.

9. A method of obtaining uniform thermal distribution in a powder bed during laser sintering accomplished by scanning a powder layer having a geometrically shaped surface with an energy beam multiple times to form a three-dimensional object comprising the steps of:
a. delivering a quantity of powder to a location in a process chamber a plurality of times;
b. spreading each quantity of powder across at least a portion of the process chamber to form a powder layer in a powder bed, the powder layer having a generally defined geometric shape;
c. exposing each powder layer with an energy beam a predetermined number of times, the beam starting at a first location and moving in a first direction for a first exposure, the beam starting at a second location and moving in a second direction orthogonally offset from the first direction for a second exposure, the beam moving in a third direction orthogonally offset from the second direction and starting at a location different than the first location and the second location for a third exposure and the beam moving in a fourth direction orthogonally offset from the third direction and starting at a location different from the first location, the second location, and the third location; and
d. repeating the delivering, spreading and exposing steps a predetermined number of times to complete building a three-dimensional object.

10. The method according to claim 9 further comprising the powder layer having a generally geometric shape with a plurality of comers, starting the movement of the energy beam from a first comer for the first exposure of powder and from a different comer for each of the second, third, and fourth exposures of powder.

11. The method according to claim 10 further comprising building multiple parts in the powder bed, each part being assigned adjacent to a comer so that the scanning movement of the energy beam begins over a different part for each layer.

12. Apparatus for laser sintering accomplished by scanning a powder layer having a geometrically shaped surface with an energy beam multiple times to form a three-dimensional object in a process chamber the apparatus achieving uniform thermal distribution in a powder bed comprising in combination:
a. means for delivering a quantity of powder to a location in the process chamber;
b. means for spreading the quantity of powder across at least a portion of the process chamber to form a powder layer in a powder bed, the powder layer having a generally defined geometric shape; and
c. means for exposing the powder layer with an energy beam, the beam starting at a first location and moving in a first direction for a first quantity of powder, the beam starting at a second location and moving in a second direction orthogonally offset from the first direction for a second quantity of powder, the beam moving in a third direction orthogonally offset from the second direction and starting at a location different than the first location and the second location for a third quantity of powder, and moving in a fourth direction orthogonally offset from the third direction and starting at a location different from the first location, the second location, and the third location for a fourth quantity of powder.
